(19) United States
(12) Patent Application Publication
(10) Pub. No.: US 2006/0087952 A1
(43) Pub. Date: Apr. 27, 2006

(54) Laser power control system

(75) Inventors: Ching-Ning Chiu, Hsin-Chu City (TW); Chih-Yuan Chen, Hsin-Chu City (TW); Jin-Chuan Hsu, Hsin-Chu City (TW)

Correspondence Address: TROXELL LAW OFFICE PLLC;SUITE 1404, 5205 LEESBURG PIKE, FALLS CHURCH, VA, 22041, US

(73) Assignee: Mediatek Inc.

(21) Appl. No.: 10/969,972

(22) Filed: Oct. 22, 2004

(51) Int. Cl. G11B 7/00

(52) U.S. Cl. 369/116; 369/47.5

(57) ABSTRACT

This invention provides a laser power control system to control the power of the emitted laser from an optical pick-up head. The system comprises a temperature sensor and a calculating unit. The temperature sensor is used to detect the temperature of the optical pick-up head and to generate a temperature signal accordingly. The calculating unit, storing a control relation of the optical pick-up head, is used to receive the temperature signal. According to the control relation, the calculating unit calculates and outputs a power control signal under the temperature signal and the setting power. The power control signal, converted from digital into analog by a digital to analog converter, is transmitted to the optical pick-up head, so as to control the optical pick-up head to emit the laser according to the setting power.

### BACKGROUND OF THE INVENTION

1. Field of the Invention

The present invention relates to a laser power control system, especially to a laser power control system used for controlling the power of an emitted laser from an optical pick-up head.

2. Description of the Related Art

Conventionally, an optical recording and reproducing system generally controls the power of a laser diode of an optical pick-up head by using an automatic power control (APC) circuit.

The APC circuit is used to compensate the outputting power error of the laser diode due to thermal effect. When the optical pick-up head is performing reading or writing process, the laser diode of the optical pick-up head generates a laser power feedback signal via a front monitor diode (FMD) to monitor the laser diode. The APC circuit uses the sample and hold (S/H) method to receive a feedback signal for keeping the power of the laser diode. For a higher recording speed or recording capacity, the speed of a response from the FMD and the frequency of the S/H method are required to be increased, otherwise an error in the feedback signal will cause inaccurate power in reading and writing process.

U.S. Pat. No. 6,671,248 discloses an apparatus of controlling the laser power. The apparatus of the prior art detects the laser temperature and the current setup of the recording power while preceding recording. When the apparatus starts newly recording, a controller is applied to detect the laser temperature and compare it with the laser temperature of the preceding recording for adjusting the current setup of the preceding recording to be the current setup of the initial power control while newly recording.

When the apparatus of the prior art starts recording, the drive current of the recording power is calculated according to the power monitor signal received by the power detecting section, and the apparatus continues repeating this recording power control loop. When the apparatus finishes recording, the laser temperature, laser drive current setting signal and the slope of the laser power from the current are saved to memory at the same time. Before the next recording starts, the detected temperature is again compared with the pre-stored data for determining the drive current while the apparatus starts recording. The apparatus of the prior art can control the drive current according to the temperature change and prevent the laser directly outputting the abnormal high power at every recording start timing.

The apparatus of the prior art is applied to obtain the laser drive current of the newly recording according to the current temperature and the data of the preceding recording. While performing recording, the control method of writing power utilizes the power monitor signal to determine the drive current.

U.S Patent application No. 2002/0064114 discloses a recording apparatus for use with optical recording medium. The recording apparatus of the prior art comprises a light source driving unit, a light power detecting unit, a temperature detecting unit, a light power control unit and a detection value storing unit. The recording apparatus of the prior art adjusts the driving current for falling the variation of the detected laser power within a predetermined range. When the detected temperature value falls within the pre-stored detected temperature range, the driving current is adjusted according to the stored detection value. The recording apparatus of the prior art can control the front monitor current to maintain a reference value, and store the driving current and temperature data during recording. When the recording apparatus restarts recording, the temperature detection value is read for generating the driving current according to the stored temperature data and driving current data.

The prior art of U.S Patent application No. 2002/0064114 is similar to the U.S. Pat. No. 6,671,248. During preceding recording, the prior art stores the temperature and the driving current for generating the newly driving current to control the recording apparatus. While performing recording, the prior art still utilizes FMD output, which is output by laser power monitor, to control the laser power within a predetermined range.

The object of the present invention is to provide a laser power control system to control the power of an emitted laser from an optical pick-up head.

In a preferred embodiment, a laser power control system is used to control the power of an emitted laser from an optical pick-up head. The laser power control system comprises a temperature sensor and a calculating unit. The temperature sensor is used to monitor the temperature of the optical pick-up head and generate a temperature signal according to the temperature. The calculating unit, including a memory, storing a predetermined control relation of the optical pick-up head, is used to receive the temperature signal. According to the control relation, the calculating unit calculates and outputs a power control signal, which is needed by a setting power, under the temperature represented by the temperature signal. The power control signal, converted from digital into analog by a digital to analog converter, is transmitted to the optical pick-up head, so as to control the optical pick-up head to emit the laser according to the setting power, and keep the output power in the setting power regardless of temperature variation.

The present invention utilizes the temperature sensor, the analog to digital converter, the calculating unit, and the digital to analog converter to control the power of the emitted laser of the optical pick-up head. The present invention simplifies the structure and is cost efficient.

These and other objectives of the present invention will no doubt become obvious to those skilled in the art after reading the following detailed description of the preferred embodiment that is illustrated in the various figures and drawings.

### BRIEF DESCRIPTION OF THE APPENDED DRAWINGS

FIG. 1 is a schematic diagram showing the laser power control system of the present invention.

FIG. 2 is a diagram showing the control relation of an output voltage of a temperature sensor and a laser power in a fixed power control signal of the laser power control system shown in FIG. 1.

FIG. 3 is a diagram of the corresponding relation of the laser power control voltage and the output laser power of the optical pick-up head under a fixed temperature shown in FIG. 1.

FIG. 4 is a flowchart showing the laser power control system generating the control relation of the present invention.

FIG. 5 is schematic diagram showing the present invention generating the control relation shown in FIG. 4.

FIG. 6 is a flowchart of the laser power controlling method of the present invention.

FIG. 7 is a flowchart of another embodiment of the present invention.

### DETAILED DESCRIPTION OF THE INVENTION

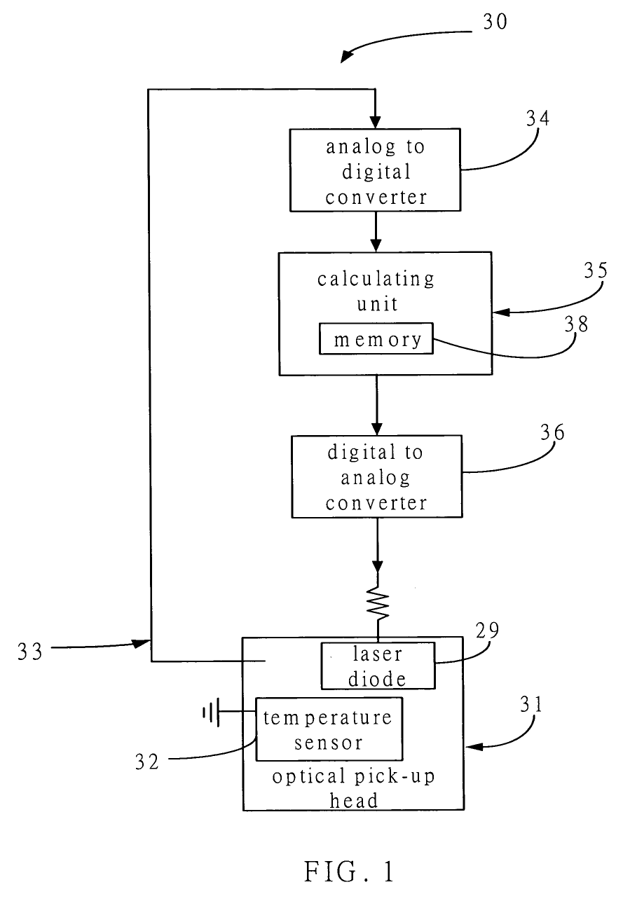

Please refer to FIG. 1. FIG. 1 is a schematic diagram showing a laser power control system 30 of the present invention. The laser power control system 30 of the present invention is used to control the power of an emitting laser of an optical pick-up head 31 when the optical pick-up head 31 is performing writing or reading process. The optical pick-up head 31 comprises a laser diode 29.

The laser power control system 30 of the present invention comprises the laser diode 29, a temperature sensor 32, an analog to digital converter 34, a calculating unit 35, and a digital to analog converter 36. The temperature sensor 32 is used to detect the temperature of the optical pick-up head 31 and generates a temperature signal 33 according to the temperature. The calculating unit 35 stores a control relation in a memory 38. The calculating unit 35 is used to receive the temperature signal 33. According to the control relation, the calculating unit 35 calculates under the temperature signal 33 and outputs a power control signal, which is needed by a setting power, to the optical pick-up head 31, so as to control the optical pick-up head 31 to emit the laser according to the setting power.

The temperature sensor 32 generates the temperature signal 33, which is an analog signal, and the temperature signal 33 is converted into a digital signal by the analog to digital converter 34. The calculating unit 35 receives the converted temperature signal 33, which is a digital signal. The calculating unit 35 outputs the power control signal, which is a digital signal, and the power control signal is converted into an analog signal by the digital to analog converter 36.

Please refer to FIG. 1. The calculating unit 35 comprises a memory 38. The memory 38 is used to store the control relation of the optical pick-up head 31, and records the relation parameter of the control relation.

In the laser power control system 30 of the present invention, the control relation means a power to control signal input curve of emitting power of the optical pick-up head and the power control signal under different temperature. A power to control signal input curve is used to contrast with a setting power under the limit of one of the many temperature signals 33, thus obtaining a corresponding power control signal. Under the different temperatures, the power to control signal input curve is corresponding to the different curves, and under a specific temperature, the present invention calculates the power control signal according to the setting power and the specific power to control signal input curve. The control relation represents the relationship of the temperature, the setting power, and the power control signal. The control relation is recorded in the memory 38 before the laser power control system 30 functions. The generating method of the power to control signal input curve is to keep the optical pick-up head 31 at a certain temperature, and the corresponding relation between an output voltage of the digital to analog converter 36 and the laser power of the optical pick-up head 31 is then measured to obtain the power to control signal input curve. In this embodiment, the present invention measures the corresponding relation between the output of the digital to analog converter 36 and the power of the emitted laser of the laser diode 29 under a specific temperature.

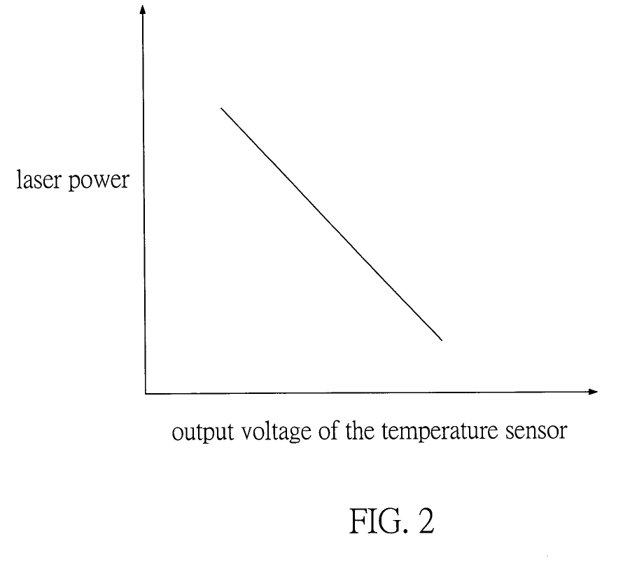

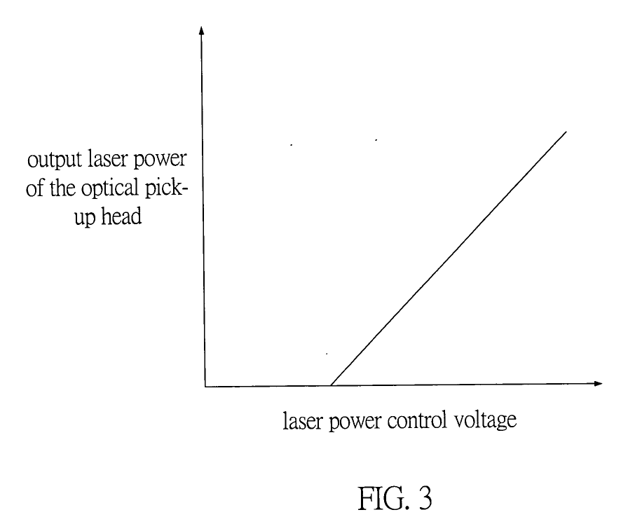

Please refer to FIG. 2 and FIG. 3. FIG. 2 is a diagram showing the relation between an output voltage of a temperature senor 32 and a laser power in a fixed power control signal of the laser power control system 30 shown in FIG. 1. The relation between the temperature and the laser power is constructed under the fix power control signal. FIG. 3 is a diagram of the corresponding relation of the laser power control voltage and the output power of the optical pick-up head 31 under a fixed temperature shown in FIG. 1. FIG. 3 is used to obtain the curve of the laser power against the power control signal. The relation parameters of the laser power, the temperature of the optical pick-up head 31 as well as the outputted signal of the digital to analog converter 36 can be obtained from FIG. 2 and FIG. 3. The memory 38 will record those parameters in advance.

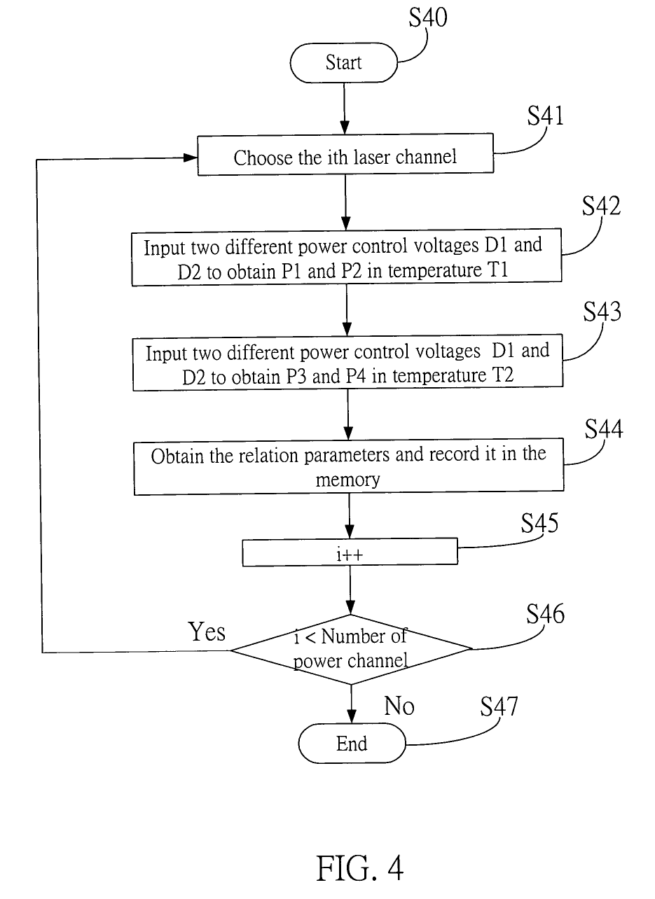

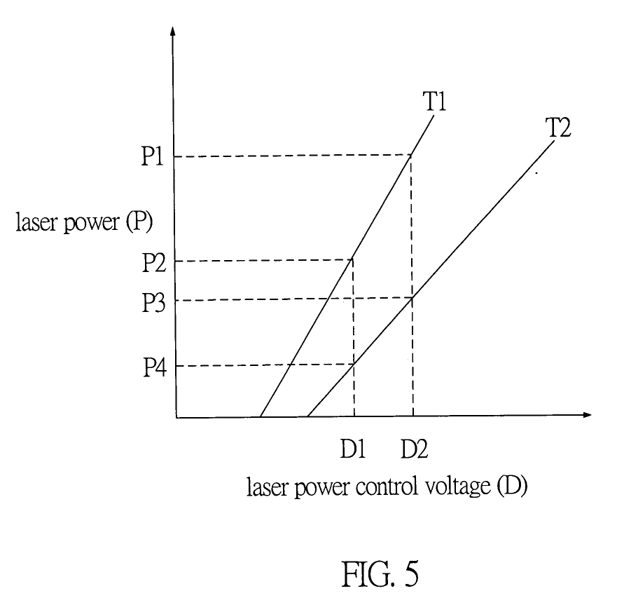

Please refer to FIG. 4 and FIG. 5. FIG. 4 is a flow chart showing the laser power control system generating a power control relation of the present invention. FIG. 5 is a schematic diagram showing the present invention generating the power control relation shown in FIG. 4. There are proportional relations between the laser power and the laser power control voltage under different temperatures. As shown in FIG. 4, the method for generating the control relation comprises the steps of:

Step 40: Start (i=1).

Step 41: Choose the ith laser power channel.

Step 42: Under temperature T1, output two different laser power control voltages D1 and D2 to the pick-up head and measure the corresponding laser power P1 and P2.

Step 43: Under temperature T2, output two different laser power control voltages D1 and D2 to the pick-up head and measure the corresponding laser power P4 and P5.

Step 44: Obtain the relation parameters of the laser power control voltages and the laser power under different temperatures, as well as record the parameters into the memory 38.

Step 45: i+1

Step 46: Determine whether i is smaller than the number of laser power channels. If yes, go to S41; if no, go to S47.

Step 47: End.

The memory 38 will save the result of the parameters of the above-mentioned steps before the laser power control system functions.

As shown in FIG. 5, the temperature T1 and T2 are temperatures of the optical pick-up head 31. Under the fixed temperature T1, the present invention inputs two different laser power control voltages D2 and D1, so as to obtain the corresponding laser power P1 and P2. Under the fixed temperature T2, the present invention inputs two different laser power control voltages D2 and D1, so as to obtain the corresponding laser power P4 and P3. The laser power control voltages (D1, D2) and the corresponding laser power (P1, P2, P3, and P4) under the different temperatures (T1 and T2) form a relation, and the relation parameters are recorded in the memory 38.

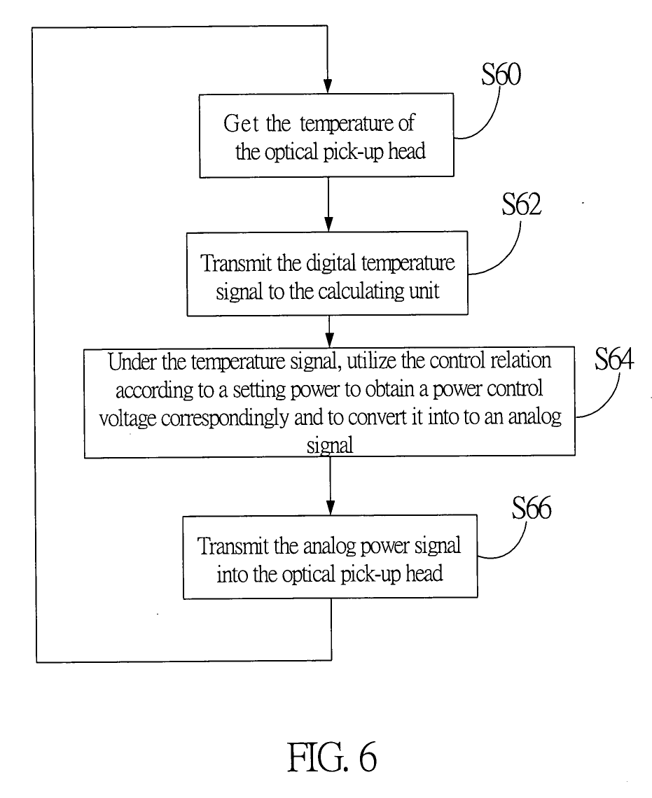

Please refer to FIG. 6 and FIG. 1. FIG. 6 is a flowchart of the laser power controlling method of the present invention. The laser power controlling method of the present invention comprises the steps of:

Step 60: Get the temperature signal 33 according to the detected temperature of the optical pick-up head 31 and convert the temperature signal 33 into a digital temperature signal 33.

Step 62: Transmit the digital temperature signal 33 to the calculating unit 35.

Step 64: Under the temperature signal 33, utilize the control relation according to a setting power to obtain a power control signal correspondingly and convert it into an analog signal.

Step 66: Transmit an analog power control signal to the optical pick-up head 31 and control it to emit laser according to the setting power.

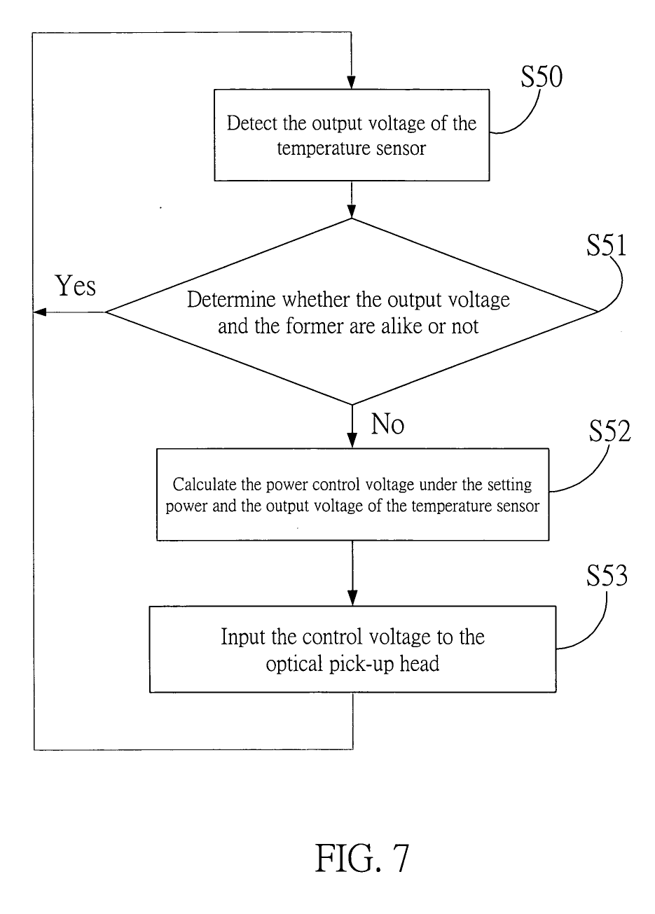

Please refer to FIG. 7. FIG. 7 is a flowchart of another embodiment of the present invention. In another embodiment, the laser power control method of the present invention comprises the steps of:

Step 50: Monitor the output voltage of the temperature sensor 32 of the optical pick-up head 31.

Step 51: Determine whether the monitored output voltage is the same as the previously monitored output voltage of the temperature sensor 32. If yes, go to step 50. If no, go to step 52.

Step 52: According to a control relation stored in advance, calculate the power control voltage under the setting power and the output voltage of the temperature sensor 32.

Step 53: Output the power control voltage to the optical pick-up head 31.

As shown in FIG. 7, in short, the present invention detects the output voltage of the temperature sensor 32 of the optical pick-up head 31 to obtain the above-mentioned temperature signal 33 and determines whether the monitored output voltage and the previously monitored output voltage of the temperature 32 are the same. If not, according to the control relation, the calculating unit 35 calculates and outputs a power control signal, which is needed by the setting power, under the temperature signal 33. The power control signal, converted from digital into analog by the digital to analog converter 36, is transmitted to the optical pick-up head 31, so as to control the optical pick-up head 31 to emit the laser according to the setting power.

Compared with the prior art, which uses a front monitoring diode (FMD) and a power control circuit to control the emitted laser power of an optical pick-up head, the present invention uses the temperature sensor 32, the calculating unit 35, and the digital to analog converter 36 to control the emitted laser power of an optical pick-up head 31. The prior art utilizes a method of sample and hold for the feedback of analog signals, but the present invention utilizes the calculating unit 35 to process signals in digital form. The structure of the present invention is simpler than that of the prior art. The present invention does not need the FMD and an APC circuit to operate, so it is cost efficient.

The other embodiment of the present invention is an optical recording apparatus. The optical recording apparatus comprises, an optical pick-up head, a laser power control system. The laser power control system is used to generate a power control signal to control the power of an emitted laser from the optical pick-up head, wherein the power control signal is a digital signal. The laser power control system comprises a temperature sensor and a calculating unit. The temperature sensor is used to detect the temperature of the optical pick-up head and generate a temperature signal according to the temperature of the optical pick-up head, wherein the temperature signal is an analog signal.

The calculating unit is used to receive the temperature signal and the setting power and storing a control relation of the optical pick-up head. The calculating unit further comprises a memory for recording a relation parameter of the control relation. The laser power control system further comprises an analog to digital converter for converting the temperature signal from an analog to a digital signal.

The control relation indicates a relation of the power control signal and a power of an emitted laser according to the temperature of the optical pick-up head. The calculate unit calculates the power control signal representing by outputting setting power to the optical pick-up head with respect to the temperature signal according to the control relation, and outputs the power control signal to the optical pick-up head for controlling the optical pick-up head to emit the laser according to the setting power. The control relation is obtained via measuring the relation between the emitting power of the optical pick-up head and the power control signal under different temperature.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A laser power control system for generating a power control signal to control the power of an emitted laser from an optical pick-up head, the system comprising:
a temperature sensor for detecting the temperature of the optical pick-up head and generating a temperature signal according to the temperature of the optical pick-up head;
a calculating unit for receiving the temperature signal and the setting power, and storing a control relation of the optical pick-up head, wherein the control relation indicates a relation of the power control signal and a power of an emitted laser according to the temperature of the optical pick-up head;
wherein the calculating unit calculates the power control signal representing by outputting setting power to the optical pick-up head with respect to the temperature signal according to the control relation, and outputs the power control signal to the optical pick-up head for controlling the optical pick-up head to emit the laser according to the setting power.

2. The system of claim 1, wherein the temperature signal is an analog signal.

3. The system of claim 1, wherein the system further comprises an analog to digital converter for converting the temperature signal from an analog to a digital signal.

4. The system of claim 1, wherein the power control signal is a digital signal.

5. The system of claim 1, wherein the system further comprises a digital to analog converter for converting the power control signal from a digital signal to an analog signal.

6. The system of claim 1, wherein the calculating unit further comprises a memory for recording a relation parameter of the control relation.

7. The system of claim 1, wherein the control relation is obtained via measuring the relation between the emitting power of the optical pick-up head and the power control signal under different temperature.

8. A laser power control method for generating a power control signal to control the power of an emitted laser from an optical pick-up head, the method comprising:
monitoring temperature of the optical pick-up head for generating a temperature signal;
storing a control relation for controlling the optical pick-up head, the control relation defining a relation between the power control signal and the power of the emitted laser with regard to the temperature of the optical pick-up head;
calculating the power control signal representing by outputting setting power to the optical pick-up head with respect to the temperature signal according to the control relation; and
outputting the power control signal to the optical pick-up head for controlling the optical pick-up head to emit the laser according to the setting power.

9. The method of claim 8, wherein the temperature signal is an analog signal.

10. The method of claim 8, wherein the method further comprises a step of:
converting the temperature signal from an analog to a digital signal.

11. The method of claim 8, wherein the power control signal is a digital signal.

12. The method of claim 8, wherein the method further comprises a step of:
converting the power control signal from a digital signal to an analog signal.

13. The method of claim 8, wherein the method further comprises a step of:
calculating the power control signal representing by the setting power with respect to the temperature signal according to the control relation, and transmitting the power control signal to the optical pick-up head for generating the laser power output of the setting power.

14. The method of claim 13, wherein the control relation is obtained via measuring the relation between the emitting power of the optical pick-up head and the power control signal under different temperature.

15. An optical recording apparatus comprising:
an optical pick-up head; and
a laser power control system for generating a power control signal to control the power of an emitted laser from the optical pick-up head, the laser power control system comprising:
a temperature sensor for detecting the temperature of the optical pick-up head and generating a temperature signal according to the temperature of the optical pick-up head; and
a calculating unit for receiving the temperature signal and the setting power and storing a control relation of the optical pick-up head, wherein the control relation indicates a relation of the power control signal and a power of an emitted laser according to the temperature of the optical pick-up head, wherein the calculate unit calculates the power control signal representing by outputting setting power to the optical pick-up head with respect to the temperature signal according to the control relation, and outputs the power control signal to the optical pick-up head for controlling the optical pick-up head to emit the laser according to the setting power.

16. The apparatus of claim 15, wherein the temperature signal is an analog signal.

17. The apparatus of claim 15, wherein the laser power control system further comprises an analog to digital converter for converting the temperature signal from an analog to a digital signal.

18. The apparatus of claim 15, wherein the power control signal is a digital signal.

19. The apparatus of claim 15, wherein the laser power control system further comprises a digital to analog converter for converting the power control signal from a digital signal to an analog signal.

20. The apparatus of claim 15, wherein the calculating unit further comprises a memory for recording a relation parameter of the control relation.

21. The apparatus of claim 15, wherein the control relation is obtained via measuring the relation between the emitting power of the optical pick-up head and the power control signal under different temperature.
